(19) United States
(12) Patent Application Publication
(10) Pub. No.: US 2006/0291784 A1
(43) Pub. Date: Dec. 28, 2006

(54) Electro-optical communication system

(76) Inventors: William H. Wang, Pleasanton, CA (US); Darren S. Crews, Santa Clara, CA (US); Brian H. Kim, Fremont, CA (US)

Correspondence Address: TROP PRUNER & HU, PC, 1616 S. VOSS ROAD, SUITE 750, HOUSTON, TX, 77057-2631, US

(21) Appl. No.: 11/167,492

(22) Filed: Jun. 27, 2005

(51) Int. Cl. G02B 6/36

(52) U.S. Cl. 385/92; 385/88

(57) ABSTRACT

Electro-optical communications may be facilitated between electrical devices by providing pluggable electro-optic modules. The pluggable electro-optic modules may be pluggingly received within U-shaped electrical connectors associated with printed circuit boards on both the receive and transmit ends. In some cases, the pluggable modules may be plugged in to establish communications and may be removed for repair or replacement.

### BACKGROUND

Embodiments of the present invention relate to the field of optical systems and more specifically, but not exclusively, to electrical optical communication.

Many of today's electronic components are coupled by way of wire cables. Wire cables may be used between computer systems and peripherals such as displays, disk drives, and printers. However, such electrical connections suffer from limitations in transmission speed and signal integrity.

Cables carrying optical signals and an optical fiber are becoming more popular. Optical signals provide higher speed and superior signal quality, as well as reduced interference from outside electromagnetic energy, in some cases. Optical cables are often connected to components using glue or screw connectors.

### BRIEF DESCRIPTION OF THE DRAWINGS

FIG. 1 is a simplified top plan view of a pair of communicating electro-optical modules in accordance with one embodiment of the present invention;

FIG. 2 is an enlarged, perspective view of one of the modules shown in FIG. 1 in position on a printed circuit board in accordance with one embodiment of the present invention;

FIG. 3 is a perspective view of the embodiment of FIG. 2 with the electro-optic module removed from the connector body in accordance with one embodiment of the present invention;

FIG. 4 is a reverse perspective view of the embodiment shown in FIG. 3;

FIG. 5 is perspective view showing the electro-optical module being plugged into the electrical connector and printed circuit board in accordance with one embodiment of the present invention;

FIG. 6 is a top plan view corresponding to FIG. 2, but after the module has advanced further inwardly, in accordance with one embodiment of the present invention;

FIG. 7 shows the electro-optic module in the course of being plugged into the connector body in accordance with one embodiment of the present invention;

FIG. 8 is a top plan view of the device fully plugged within a connector in one embodiment of the present invention;

FIG. 9 is a partial, enlarged, cross-sectional view taken generally along the line 9-9 in FIG. 8;

FIG. 10 is an exploded, perspective view of one embodiment of the electro-optic device in accordance with one embodiment of the present invention;

FIG. 11 is an exploded, perspective view of the bottom of the electro-optic device in accordance with one embodiment of the present invention;

FIG. 12 is an enlarged, cross-sectional view taken generally along the line 12-12 in FIG. 8;

FIG. 13 is a system depiction in accordance with one embodiment of the present invention; and

FIG. 14 is a more detailed system depiction in accordance with one embodiment of the present invention.

### DETAILED DESCRIPTION

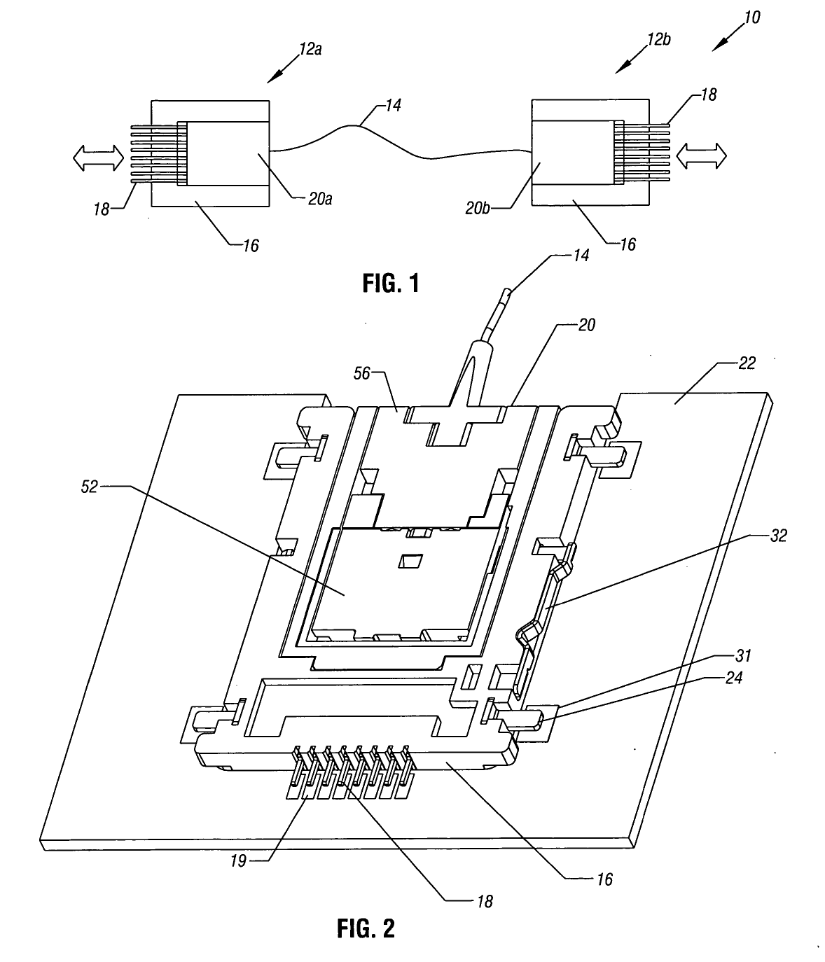

Referring to FIG. 1, an optical communication system 10 may include a transmitting electro-optical assembly 12a and a receiving electro-optic assembly 12b. Thus, electrical signals may be received on the pins 18 and converted to optical signals by the electro-optical device 20a. The optical signals are then sent over the optical cable 14 to the receiving electro-optic assembly 12b. The receiving assembly includes an electro-optical device 20b that converts the received optical signals into electric signals, which may then be transferred to another system through the electrical leads 18.

In this way, one electrical system may communicate with another electrical system over an optical communication link. There is no limitation on what types of electrical systems may communicate over such an optical link. Also, the cable 14 is not limited to optical fiber only or just one line, it can be a combination of several electrical lines and optical fibers. As examples, a computer may communicate with other computers or its own peripherals over such a link.

Each of the devices 20 electrically plug into a U-shaped electrical connector 16. Thus, plugs on one of the connector 16 and device 20 are received within sockets on the other of the connector 16 and device 20.

Referring to FIG. 2, the electrical connector 16 may be surface mounted to a printed circuit board 22 associated with an electronic system. As shown in FIG. 2, the electro-optic cable 14 communicates by a connector module 56 with a molded lens module 52.

The connector 16 includes surface mountable legs 24 that electrically and physically connect by surface mounts to lands 31 on the printed circuit board 22. A series of connector 16 leads 18 may be surface mounted on bond pads 19 which are part of the printed circuit board 22 in one embodiment. Thus, the electro-optical device 20 may be plugged into an electrical connector 16 that may be surface mounted onto a printed circuit board 22. This provides for easy plugging engagement. The electro-optical device 20 may be releasably held on the connector 16 by a latch 32.

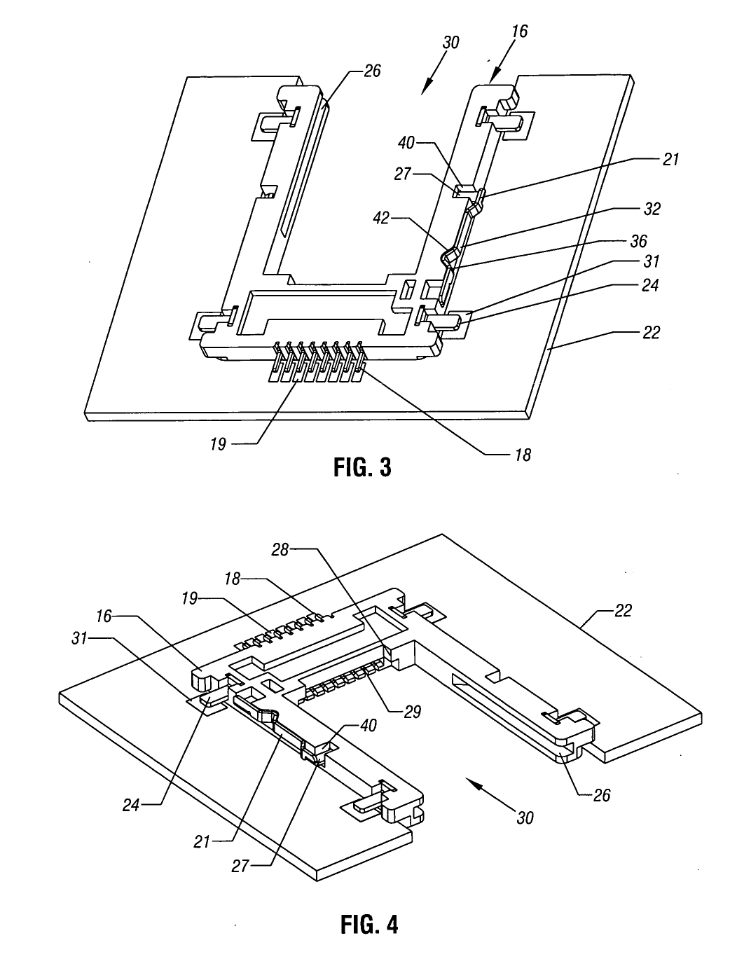

Thus, referring to FIG. 3, which shows the assembly of FIG. 2 with the device 20 removed, a grooved track 26 is provided within a slot 30 that pluggingly receives the device 20. In addition, the latch 32 includes a cantilevered spring arm with a pin 27 that is releasably engaged within a notch 40 on the connector 16. Thus, the free end 21 of the latch 32 may be spring biased by its own internal resiliency. Inward force is applied by the latch 32 to engage the pin 27 in the notch 40 in a connector 16. The pin 27 extends generally transversely to the length of the free end 21. In addition, an offset section 36 of the latch 32 may engage another notch 42 in the connector 16. Because of the cammed or angled sides on the offset section 36, the offset section 36 may releasably engage the notch 42.

Similarly, as shown in FIG. 4, a series of electrically receiving female socket 29 may be arranged in the connector 16 slot 30 to receive mating electrical elements on the device 20, once plugged into the slot 30.

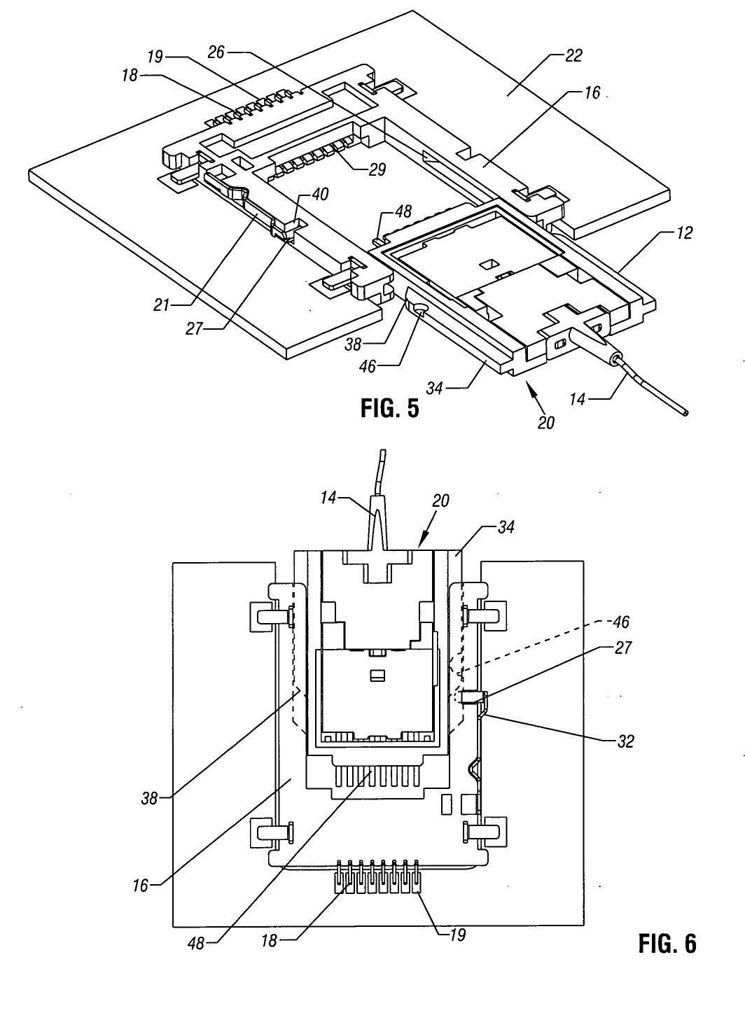

Referring to FIG. 5, the device 20 may be engaged with its lateral flanges 34 arranged to ride within the opposed connector guide tracks 26 in the connector 16. A cammed leading edge 38 is located on the leading edge of each flange 34. A slot 46 is defined in the flange 34 in one embodiment. Thus, a plugging relationship may be achieved as the device 20 is moved from right to left in FIG. 5 so that the electrical pins 48 on the device 20 ultimately engage the receiving plugs 29.

As shown in FIG. 6, the slot 46, along the flange 34, may eventually be engaged by the pin 27. The slot 46 may have a rounded contour which may have a larger radius than the radius of the end of the pin 27. Thus, the pin 27 may be spring biased into the slot 46, but with a forceful pull can be disengaged to allow the device 20 ultimately to be removed.

In another embodiment, the slot 46 may have a rectangular contour. When trying to pull out the device 20, the straight edge of the slot 46 will be in contact with the straight edge of the pin 27. Thus, there is no ramp or rounded contour on the slot 46 for pin 27 to slide out of the slot 46. Disengagement can only be done by manually deflecting the latch 32 to allow the pin 27 to come out of the slot 46.

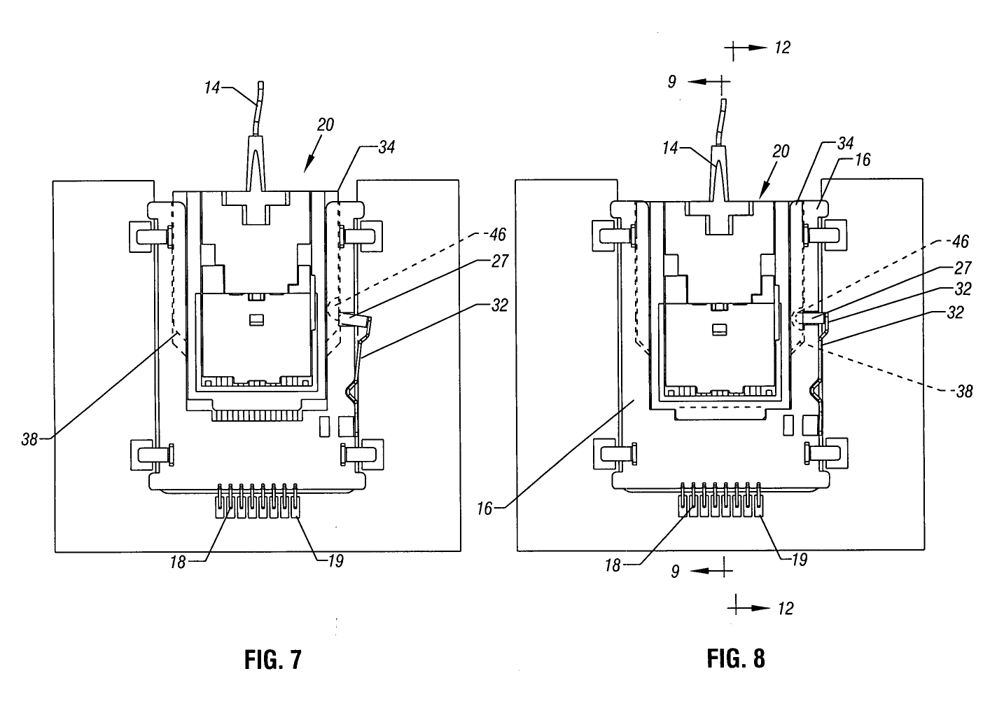

The engagement between the connector 16 and the device 20 is facilitated by the cammed leading edge 38 of the flange 34 as shown in FIG. 6. Initially, the end of the pin 27 is engaged by the edge 38 and cammed outwardly to allow passage of the device 20 and its track 34. Thereafter, as the device 20 proceeds inwardly into the slot 30, the pin 27 rides on the facing edge of the flange 34, as shown in FIG. 7.

Thus, referring to FIG. 8, the pin 27 is engaged within a slot 46 in the track 34. In this position, the device 20 is releasably held within the connector 16 on the printed circuit board 22. In such a configuration, optical signals inbound to the device 20 may be converted to electrical signals outbound from the device 20 to the printed circuit board 22. Similarly, inbound electrical signals can be converted into optical signals in the module 52 and passed outwardly through module 56 to the cable 14.

If it is desired to remove the device 20 from the connector 16, either the latch 32 may be manually displaced or, if sufficient force is applied, the device 20 may be disengaged. Then, either the connector or the device 20 and cable 14 may be replaced or repaired during such disengagement.

Ultimately, upon alignment between the slot 46 and the pin 27, the pin 27 is shoved into the slot 46 by the natural resiliency of the latch 32. In this position, the cammed edge 38 may be close to or in contact with the connector 16. As a result, the device 20 is releasably latched in the connector 16, as shown in FIG. 8.

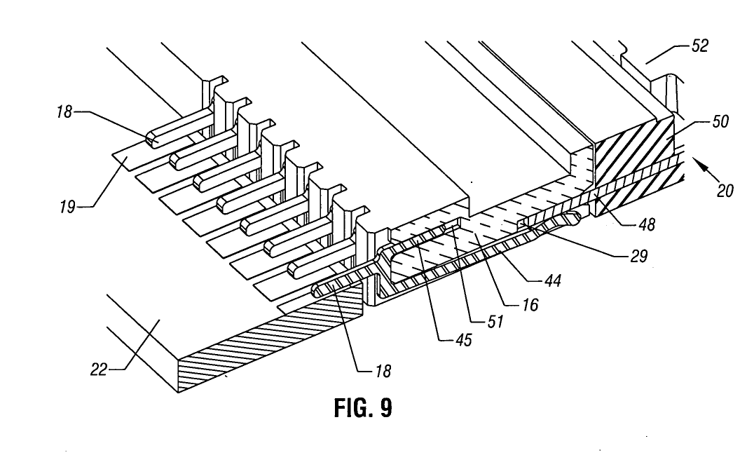

The leads 18 have the lower extension 44 and the upper extension 45. Thus, referring to FIG. 9, the leads 18 are pre-assembled to the electrical connector 16, for example, by a force fit of their upper extension 45 to the slots 51 of the electrical connector 16. The socket 29 is formed of the space between the lower extension 44 of the leads 18 and the connector 16. The leads 18 may be held by a snap fit or frictional connection within slots 51 of the electrical connector 16. This leaves an extension 44 of each lead 18 that extends outwardly. The free end of the extension 44 may be curved so as to make a plugging electrical connection with the pins 48 on the devices 20. Thus, the device 20 can effectively plug right into the socket 29 of the electrical connector 16 with electrical contact being made between the pins 48 and the extensions 44.

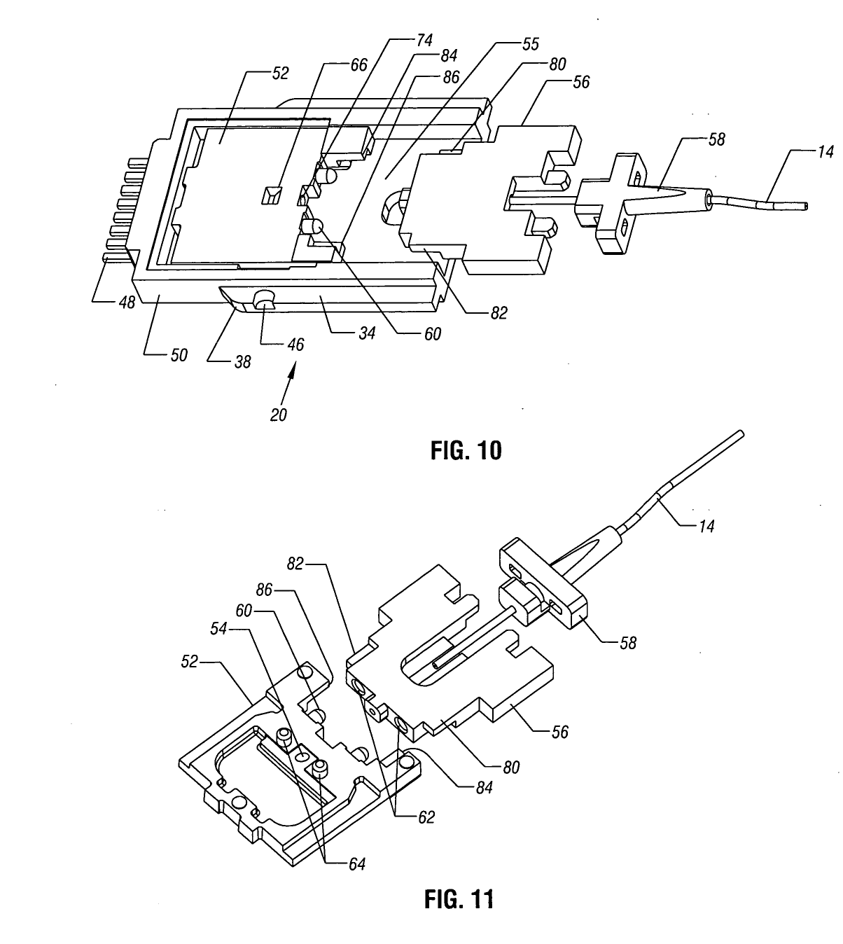

Referring to the exploded depiction of FIG. 10, the cable 14 extends through the strain relief 58 which is secured to the optical connector module 56. In fact, the cable 14 extends into the module 56. The module 56 is engaged within the molded lead frame 50 and, ultimately, plugs into the molded lens module 52. Thus, the lead frame 50 may be U-shaped in one direction, providing a support surface 55 that mounts and receives the modules 56 and 52. The molded lead frame 50 also includes the flange 34, the slot 46, and the cammed edge 38, as well as the pins 48.

Also formed in the molded lens module 52 is a 45 degree mirror area 66. A fiber side lens 74 is also formed integrally into the molded lens module 52 in some embodiments. The module 52 may also include locating post 60 to align the modules 52 and 56.

As shown in FIGS. 10 and 11, the module 56 includes a lower flange 80 on one side and a higher flange 82 on the other side. The module 52 includes a mating higher flange 84 on one side and lower flange 86 on the other side. Thus, the flange 80 is locked under the flange 84 and the flange 86 is locked under the flange 82 when the two modules 52 and 56 are plugged together.

As shown in FIG. 11, locating holes 62 are arranged to be engaged by in a plug fit with the locating posts 60 on the module 52. A lens array 54 is provided on the molded lens module 52. Locating posts 64 are provided on the molded lens module 52 for engaging the corresponding holes on the molded lead frame 50 in a vertical engagement. Thus, the molded lens module 52 may be locked on the molded lead frame 50.

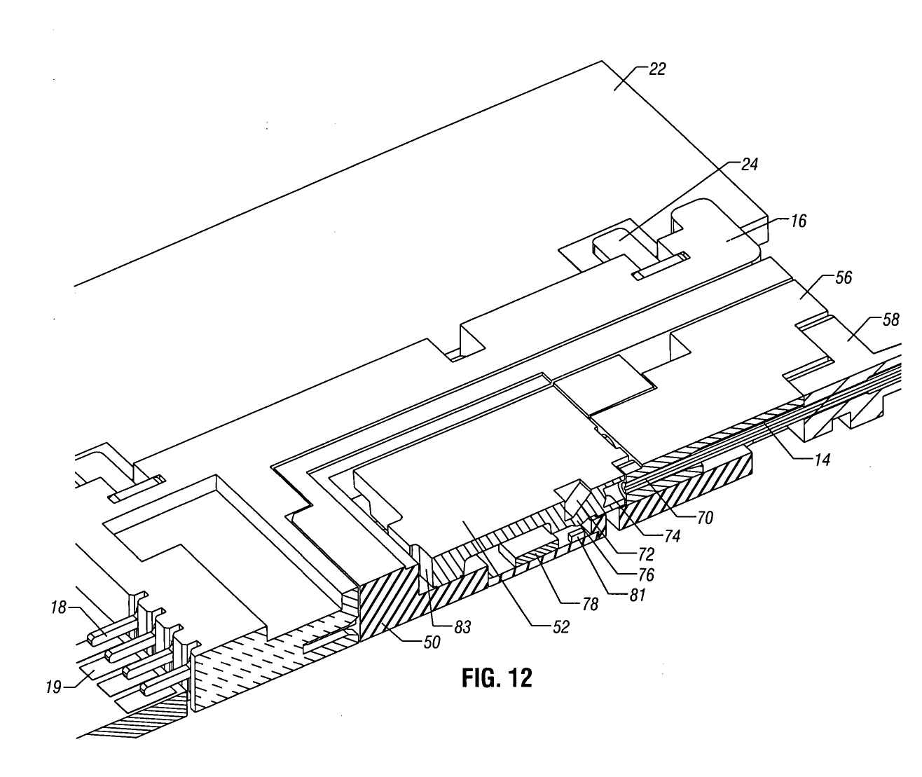

In one embodiment, as shown in FIG. 12, the end 70 of the cable 14 is arranged proximately to an opening in the molded lens module 52. At an opposed end of that opening is the integrally molded fiber side aspherical lens 74. However, spherical lenses may also be used. Since the molded lens module 52 is made of a light transparent material, light from the free end 70 passes through the cavity in the module 52 and is focused by the fiber side lens 74 onto an integrally formed mirror 72. The mirror 72 then reflects the light downwardly, in the case of a receiving embodiment, to the pin diode 81. The light from the mirror 72 passes through the integral device side aspherical lens 76 also formed as part of the module 52.

Conversely, in the case of a transmitter, the element 81 may be a light emitter such as a vertical cavity emitting laser (VCEL). Light from the transmitting element 81 is focused by the lens 76 onto the mirror 72 where it is reflected to pass outwardly through the lens 74 into the free end 70 of the cable 14. An element 78 may be a driver chip for a transmitter or a receiver chip for a receiver. A glue channel 83 may be provided to glue the module 52 into the molded lead frame 50.

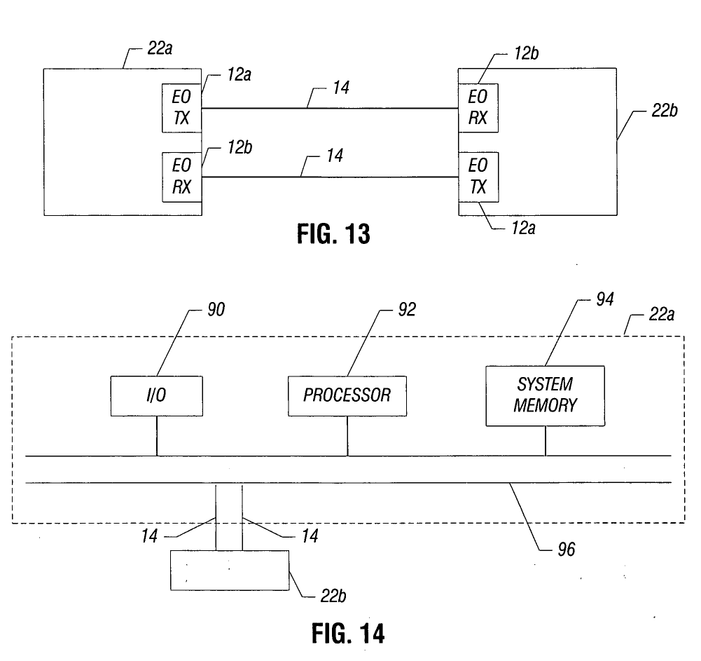

Referring then to FIG. 13, a system may be formed with a transmitting electro-optical device 12a, formed on a printed circuit board 22a, that communicates by a cable 14 with a receiving electro-optical device 12b on another printed circuit board 22b. The printed circuit board 22b may have its own electro-optical transmitting device 12a that communicates by a cable 14 with the receiving device 12b on the printed circuit board 22a. Thus, electrical systems, components, or peripherals may communicate through their printed circuit boards 22, the electro-optical devices 12, and the cable 14 in both a transmit and a receive fashion in some embodiments.

Referring finally to FIG. 14, the printed circuit board 22 on which a device 12 is mounted may include, in some embodiments, a processor 92, an input/output device 90, and a system random access memory 94. These components are coupled by a bus 96. The bus 96 may, in turn, coupled through electro-optical devices (not shown) with the cables 14.

The cables 14 provide optical communications with the printed circuit board 22b. The printed circuit board 22b may be associated with another computer system, a networked device, a server, or a peripheral associated with the printed circuit board 22a, to mention a few examples. For example, in one embodiment, the printed circuit board 22a may provide a computer system that connects to peripherals that include printed circuit boards 22b.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a pluggable, planar, female electrical connector to receive a planar, male electro-optical module within said connector in a coplanar relationship; and
surface mounting said connector to a printed circuit board.

2. The method of claim 1 including providing a U-shaped pluggable electrical connector, arranged to pluggingly receive an electro-optical module.

3. The method of claim 2 including providing mating tracks and grooves in said module and said connector.

4. The method of claim 1 including releasably latching said electro-optical module within said connector.

5. The method of claim 4 including providing a cantilevered spring having a pin on its free end.

6. The method of claim 5 including causing said spring and pin to be cammed away from said electro-optical module as it is plugged into said electrical connector.

7. The method of claim 6 including releasably retaining said pin within a notch in said electo-optical module.

8. The method of claim 1 including providing two pluggable units within said electro-optical module, one of said units being integrally molded.

9. The method of claim 8 including integrally molding two lenses and a reflector in said integrally molded unit.

10. The method of claim 9 including holding said units in alignment on a molded body that electrically connects to said connector.

11. An electro-optical assembly comprising:
a planar, U-shaped surface mountable electrical connector;
a pluggable, planar electro-optic device, slidably pluggable into said electrical connector in a coplanar relationship.

12. The assembly of claim 11 including a U-shaped electrical connector having a slot and a pair of opposed arms, said slot between said arms, said arms to slidingly receive said electro-optic device.

13. The assembly of claim 12 including a track in one of said connector and said device and a flange in one of said connector in said device, said track being engaged by said flange.

14. The assembly of claim 11 including a latch removably to latch said electro-optic device within said connector.

15. The assembly of claim 14 wherein said latch includes a cantilevered spring having a pin at its free end, said pin to engage a notch in said electro-optic device.

16. The assembly of claim 15 wherein said flange is on said electro-optic device and said track is in said connector, said flange having a cammed end to cam said pin outwardly as said device is plugged into said connector.

17. The assembly of claim 16 wherein said pin is releasably retained within said notch in said device.

18. The assembly of claim 11, said device including two pluggable units, one of said units being integrally molded.

19. The assembly of claim 18 wherein said integrally molded unit includes two integrally molded lenses and a reflector.

20. The assembly of claim 19 wherein said units are aligned by alignment devices including a pin on one of said units and a mating opening in the other of said units.

21. A system comprising:
a first printed circuit board, a first planar, female connector surface mounted on said first printed circuit board, and a first planar, female electro-optic device pluggingly insertable into said first connector in a coplanar relationship;
an optical cable coupled to said first electro-optical device; and
a second printed circuit board, said second printed circuit board including a second connector and a second electro-optic device pluggingly insertable into said second connector, said cable coupled to said second electro-optic device.

22. The system of claim 21 wherein said first and second connectors have a slot and a pair of opposed arms, said slot between said arms, said arms to slidingly receive an electro-optical device.

23. The system of claim 21 including a latch to releaseably latch said first electro-optic device in said first connector.

24. The system of claim 23 wherein said latch includes a cantilevered spring having a pin on its free end, said pin to engage a notch in said electro-optic device.

25. The system of claim 24 wherein one of said device and said connector includes a flange to ride in a track in the other said device and said connector.

26. The system of claim 25 wherein said flange is on said electro-optic device and said track is in said connector, said flange having a cammed edge to cam said pin outwardly as said device is plugged into said connector.

27. The system of claim 26 wherein said pin is releasably retained within said notch in said device.

28. The system of claim 21, said first electro-optic device including two pluggable units, one of said units being integrally molded, said integrally molded unit including two integrally molded lenses and a reflector.

29. The system of claim 28 wherein said units are aligned by alignment devices including a pin on one of said units and a mating opening the other of said units.

30. The system of claim 21 wherein one of said electro-optic devices to convert an electrical signal to an optical signal and the other of said electro-optic devices to convert an optical signal to an electrical signal.
